(19) United States
(12) Patent Application Publication
(10) Pub. No.: US 2026/0239489 A1
(43) Pub. Date: Aug. 13, 2026

(54) METHOD FOR SINGLE DRX CONFIGURATION FOR XR

(71) Applicant: Continental Automotive Technologies GmbH, Hannover (DE)

(72) Inventors: Rikin SHAH, Langen, Hessen (DE); David Gonzalez Gonzalez, Egelsbach, Hessen (DE); Hojin KIM, Regensburg (DE); Andreas ANDRAE, Frankfurt am Main (DE); Reuben GEORGE STEPHEN, Singapore (SG); Shravan Kumar KALYANKAR, Singapore (SG)

(73) Assignee: Continental Automotive Technologies GmbH, Hannover (DE)

(21) Appl. No.: 19/471,761

(22) PCT Filed: Apr. 3, 2024
(86) PCT No.: PCT/EP2024/059084

§ 371 Date: Oct. 2, 2025

(30) Foreign Application Priority Data
Apr. 5, 2023 (DE) 10 2023 203 191.4

(51) Int. Cl. H04W 76/28; H04W 72/232; H04W 76/38

(52) U.S. Cl. CPC H04W 76/28; H04W 72/232; H04W 76/38

(57) ABSTRACT

A method for discontinuous reception, DRX, configuration, the method being implemented by a user equipment, UE. The UE is configured with a DRX cycle including an active time and an inactive time. The active time is configured by a drx-onDurationTimer and a drx-InactivityTimer. The method includes: in response to receiving, during the active time and from a base station, BS, an indication of an adjustment of the drx-onDurationTimer/drx-InactivityTimer values: modifying the drx-onDurationTimer/drx-InactivityTimer values based on the indicated adjustment; in response to receiving no adjustment indication from the BS: continuing with the same drx-onDurationTimer/drx-InactivityTimer values.

### CROSS REFERENCE TO RELATED APPLICATIONS

This application is the U.S. National Phase Application of PCT International Application No. PCT/EP2024/059084, filed Apr. 3, 2024, which claims priority to German Patent Application No 10 2023 203 191.4 filed Apr. 5, 2023, the contents of such applications being incorporated by reference herein.

### FIELD OF THE INVENTION

The present disclosure relates to wireless communication systems and relates more specifically to methods and devices for enabling a dynamic configuration of a discontinuous reception, DRX, cycle at a user equipment, UE. Such a dynamic configuration can be used, for example, in the context of extended reality, XR.

### BACKGROUND OF THE INVENTION

For the NR technology, DRX procedures for downlink (DL)/uplink (UL) communication via the Uu radio interface are specified in 3GPP TS 38.321 V16.0.0 (2020-03). Based on these procedures, expected UE behavior in terms of reception and processing of transmissions can be controlled. The underlying DRX functionalities are based on defining a DRX active time, in which the UE is expected to receive and process incoming transmissions. For example, the UE is expected to decode the DL control channels, process received grants, etc. Outside the DRX active time, in what is also denoted as DRX inactive time, there is no expectation on the UE to receive and process transmissions. Accordingly, an access node, in the NR technology denoted as “gNB”, cannot assume that the UE will be listening to DL transmissions. A DRX configuration may also define transitions between states. Typically, UEs that are not in the DRX active time turn off some of their components and enter a low-power mode, e.g., a sleeping mode. To ensure that the UE regularly switches to the DRX active time, i.e., wakes up from the sleeping mode, a DRX cycle is defined. The DRX cycle may basically be based on two parameters: a periodicity of the DRX cycle, which controls how frequently the UE switches to the DRX active time, and a duration of the DRX active time, which controls for how long the UE is in the DRX active state.

According to section 5.7 of 3GPP TS 38.321 V16.0.0, when a DRX cycle is configured, the active time for serving cells in a DRX group includes the time while a drx-onDurationTimer or a drx-InactivityTimer configured for the DRX group is running.

In applications such as XR, it is possible to have devices which may support multiple traffic flows such as audio, video, I/P frame. Furthermore, each traffic flow can have different traffic pattern with different traffic periodicity. Current specifications allow a single DRX configuration per serving cell. However, a single DRX configuration cannot match the characteristics of all possible XR traffic flows. As a result, a gNB has to configure longer drx-onDurationTimer/drx-InactivityTimer to cover all traffic flows which results in increased UE power consumption.

### SUMMARY OF THE INVENTION

The present disclosure aims at improving the situation. In particular, the present disclosure aims at addressing at least some of the limitations of the prior art discussed above. In particular, the present disclosure aims at proposing a solution enabling to reduce UE power consumption when a single DRX configuration is configured by a gNB.

For that purpose, it is proposed that the network configures drx-onDurationTimer/drx-InactivityTimer dynamically for each DRX cycle.

According to a first aspect, the present disclosure relates to a method for discontinuous reception, DRX, configuration, the method being implemented by a user equipment, UE, wherein the UE is configured with a DRX cycle comprising an active time and an inactive time, wherein the active time is configured by a drx-onDurationTimer and a drx-InactivityTimer, wherein the method comprises:
in response to receiving, during the active time and from a base station, BS, an indication of an adjustment of the drx-onDurationTimer/drx-InactivityTimer values: modifying the drx-onDurationTimer/drx-InactivityTimer values based on the indicated adjustment,
in response to receiving no adjustment indication from the BS: continuing with the same drx-onDurationTimer/drx-InactivityTimer values.

Hence, a single DRX configuration may be adjusted at each DRX cycle, such that it is possible to adjust the active time at each DRX cycle with a single DRX configuration. For example, the active time may be adjusted to the considered traffic flow, thereby reducing power consumption at the UE.

In some embodiments, the method according to the first aspect can further comprise one or more of the following optional features, considered either alone or in any technically possible combination.

In some embodiments of the method according to the first aspect, the adjustment of the drx-onDurationTimer/drx-InactivityTimer values is determined based on at least one index indicated by the BS.

In some embodiments of the method according to the first aspect, the adjustment of the drx-onDurationTimer/drx-InactivityTimer values is determined based on at least one mapping table between a plurality of indexes and respective timer values.

In some embodiments of the method according to the first aspect, the adjustment of the drx-onDurationTimer/drx-InactivityTimer values is determined based on a first mapping table between a plurality of indexes and respective drx-onDurationTimer values and based on a second mapping table between a plurality of indexes and respective drx-InactivityTimer values.

In some embodiments of the method according to the first aspect, the at least one mapping table between a plurality of indexes and respective timer values is provided to the UE through dedicated radio resource control signaling.

In some embodiments of the method according to the first aspect, the adjustment indication is done based on downlink control information, DCI, or medium access control, MAC, control element, CE.

In some embodiments of the method according to the first aspect, the adjustment indication is UE specific or for a group of UEs which have same traffic flows.

According to a second aspect, the present disclosure relates to a user equipment, UE, comprising a wireless transceiver, a processor coupled with a memory in which computer program instructions are stored, said instructions being configured to implement a method according to any one of the embodiments of the first aspect.

According to a third aspect, the present disclosure relates to a method for discontinuous reception, DRX, configuration, the method being implemented by a base station, BS, wherein a UE is configured with a DRX cycle comprising an active time and an inactive time, wherein the active time is configured by a drx-onDurationTimer and a drx-InactivityTimer, wherein the method comprises transmitting to the UE an indication of an adjustment of the drx-onDurationTimer/drx-InactivityTimer values during the active time of the DRX cycle.

In some embodiments, the method according to the third aspect can further comprise one or more of the following optional features, considered either alone or in any technically possible combination.

In some embodiments, the method according to the third aspect comprises determining an index based on a traffic flow of the UE and wherein the index is transmitted to the UE as an indication of an adjustment of the drx-onDurationTimer/drx-InactivityTimer values.

In some embodiments, the method according to the third aspect comprises transmitting to the UE at least one mapping table between a plurality of indexes and respective timer values.

In some embodiments, the method according to the third aspect comprises transmitting to the UE a first mapping table between a plurality of indexes and respective drx-onDurationTimer values and a second mapping table between a plurality of indexes and respective drx-InactivityTimer values.

In some embodiments of the method according to the third aspect, the at least one mapping table between a plurality of indexes and respective timer values is transmitted through dedicated radio resource control signaling.

In some embodiments of the method according to the third aspect, the adjustment indication is based on downlink control information, DCI, or medium access control, MAC, control element, CE.

In some embodiments of the method according to the third aspect, the adjustment indication is UE specific or for a group of UEs which have same traffic flows.

According to a fourth aspect, the present disclosure relates to a base station, for example a gNB, comprising a wireless transceiver, a processor coupled with a memory in which computer program instructions are stored, said instructions being configured to implement a method according to any one of the embodiments of the third aspect.

According to a fifth aspect, the present disclosure relates to a wireless communication system comprising a base station, for example a gNB, according to any one of the embodiments of the present disclosure and a user equipment, UE, according to any one of the embodiments of the present disclosure.

### BRIEF DESCRIPTION OF THE DRAWINGS

Aspects of the invention will be better understood upon reading the following description, given as an example that is in no way limiting, and made in reference to the figures which show:

FIG. 1 is a schematic representation of an example of a user equipment, UE,

FIG. 2 is a schematic representation of an example of a BS,

FIG. 3 shows an exemplary flow proceeded by a gNB,

FIG. 4 shows an exemplary flow proceeded by a UE,

FIG. 5 shows an example in which the UE applies an ODT2 timer value for drx-onDurationTimer for a DRX cycle 2 upon receiving an indication of an index X2 from the network during a DRX cycle 1.

### DETAILED DESCRIPTION OF EXEMPLARY EMBODIMENTS

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc.), Operations & Maintenance (O&M), Operations Support System (OSS), Self-Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment.” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

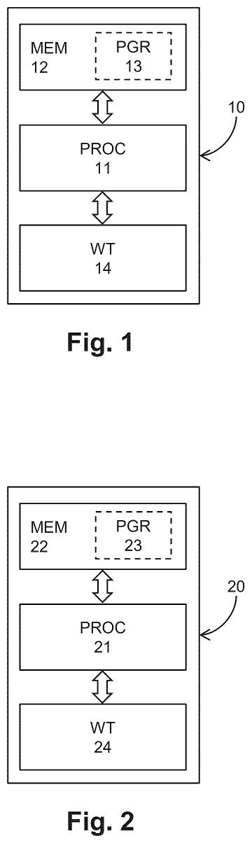

FIG. 1 represents schematically an example of a UE 10 suitable for implementing any method, discussed in the present disclosure, performed at a UE 10. As illustrated by FIG. 1, the UE 10 comprises a processor 11 coupled to a memory 12. The memory 12 may store a computer program product 13, in the form of computer program instructions to be executed by the processor 11 to implement a method for DRX configuration, performed at a UE's side, according to any one of the embodiments disclosed herein. As illustrated by FIG. 1, the UE 10 comprises also a wireless transceiver 14 configured to exchange data with a base station, BS, 20. For example, the wireless transceiver 14 is a 5G NR wireless transceiver.

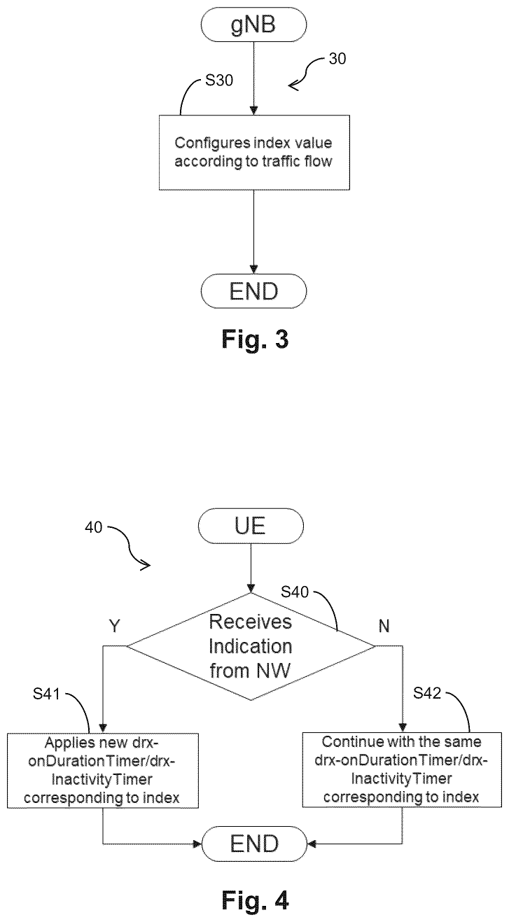

FIG. 2 represents schematically an example of a BS 20 suitable for implementing any method, discussed in the present disclosure, performed at a BS 20. For example, the BS 20 is a gNB. As illustrated by FIG. 2, the BS 20 comprises a processor 21 coupled to a memory 22. The memory 22 may store a computer program product 23, in the form of computer program instructions to be executed by the processor 21 to implement a method for DRX configuration, performed at a BS's side, according to any one of the embodiments disclosed herein. As illustrated by FIG. 2, the BS 20 comprises also a wireless transceiver 24 configured to exchange data with UEs. In preferred embodiments, the wireless transceiver 24 is 5G NR wireless transceiver.

As discussed above, the present disclosure aims at proposing a solution enabling to reduce UE power consumption when a single DRX configuration is configured by a gNB.

In the prior art, the network configures the drx-onDurationTimer/drx-InactivityTimer values semi-statically through radio resource control, RRC, signaling and the UE then applies the same drx-onDurationTimer/drx-InactivityTimer values in each DRX cycle. With such a single semi-static DRX configuration, handling e.g. different traffic flows requires to configure longer drx-onDurationTimer/drx-InactivityTimer which results in increased UE power consumption.

In the present disclosure, it is proposed that the network (e.g., a gNB) may configure the drx-onDurationTimer/drx-InactivityTimer dynamically for each DRX cycle, for example based on the traffic flows. In some examples, such a dynamic adjustment can be done via downlink control information, DCI, or medium access control, MAC, control element, CE.

FIG. 3 represents a diagram showing steps of an exemplary embodiment of a method 30 for DRX configuration, which is implemented by a gNB 20.

As illustrated by FIG. 3, the method 30 for DRX configuration comprises a step S30 of transmitting to the UE 10 an indication of an adjustment of the drx-onDurationTimer/drx-InactivityTimer values during the active time of the DRX cycle.

In the non-limitative example of FIG. 3, the adjustment indication is transmitted as an index, and the index is determined based on a traffic flow of the UE 10.

As indicated above, in some examples, the adjustment indication (e.g., index) may be transmitted as DCI or a MAC CE. In some examples, the adjustment indication (e.g., index) may be UE specific or it may apply to a group of UEs which have same traffic flows.

FIG. 4 represents a diagram showing steps of an exemplary embodiment of a method 40 for DRX configuration, which is implemented by a UE 10.

As illustrated by FIG. 4, the method 40 for DRX configuration comprises a step S40 of evaluating whether an indication of an adjustment of the drx-onDurationTimer/drx-InactivityTimer values is received from the gNB 20. In the example of FIG. 4, it is assumed in a non-limitative manner that the adjustment indication comprises an index from which the UE 20 may determine the adjustment to be applied to the drx-onDurationTimer/drx-InactivityTimer values.

If an adjustment indication is received during the active period, then the method 40 for DRX configuration comprises a step S41 of modifying the drx-onDurationTimer/drx-InactivityTimer values based on the indicated index. In turn, if no adjustment indication is received from the gNB 20 (i.e., the gNB 20 does not indicate that the drx-onDurationTimer/drx-InactivityTimer values need to be modified), then the method 40 for DRX configuration comprises a step S42 of continuing with the same drx-onDurationTimer/drx-InactivityTimer values as configured previously.

As indicated above, the UE 10 may determine the adjustment of the drx-onDurationTimer/drx-InactivityTimer values based on the index indicated by the gNB 20.

For example, the UE 10 may be preconfigured with at least one mapping table between a plurality of indexes and respective timer values. For example, the UE 10 may be preconfigured with two such mapping tables:
a first mapping table between a plurality of indexes and respective drx-onDurationTimer values, and
a second mapping table between a plurality of indexes and respective drx-InactivityTimer values.

In some embodiments, the one or more mapping tables between a plurality of indexes and respective timer values may be provided to the UE 10 by the gNB 20. For example, these one or more mapping tables between a plurality of indexes and respective timer values may be provided to the UE 10 through dedicated RRC signaling.

Table 1 represents an example of a mapping between a plurality of indexes and respective drx-onDurationTimer values.

TABLE 1

| Index | drx-onDurationTimer |
|---|---|
| X1 | ODT1 |
| X2 | ODT2 |
| X3 | ODT3 |

Table 2 represents an example of a mapping between a plurality of indexes and respective drx-InactivityTimer values.

TABLE 2

| Index | drx-InactivityTimer |
|---|---|
| Y1 | IT1 |
| Y2 | IT2 |
| Y3 | IT3 |

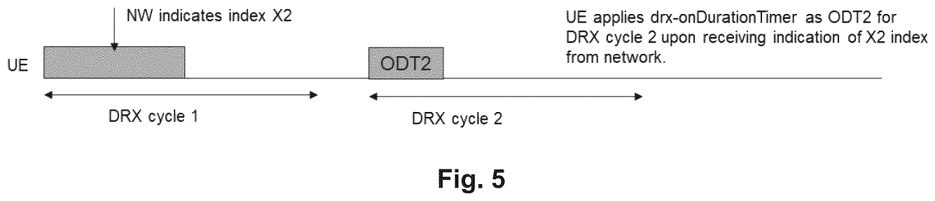

FIG. 5 shows an example in which two successive DRX cycles are represented and referred to as “DRX cycle 1” and “DRX cycle 2”. During the active period of the DRX cycle 1, the UE 10 receives from the gNB 20 an indication of the index X2. According to the mapping table illustrated by Table 1, the drx-onDurationTimer value associated to the index X2 corresponds to ODT2. Hence, during the DRX cycle 2, the UE 10 uses a drx-onDurationTimer having a value ODT2.

It is emphasized that the present disclosure is not limited to the above exemplary embodiments. Variants of the above exemplary embodiments are also within the scope of the present disclosure.

It should be noted that the following exemplary embodiments are also included in the present disclosure.

Embodiment 1: Method for Single DRX configuration for XR, wherein UE receives indication from NW and in case of no indication is received UE continues with the same adjustment for drx-onDurationTimer/drx-InactivityTimer corresponding to index and in case of indication is received UE applies new drx-onDurationTimer/drx-InactivityTimer corresponding to index.

Embodiment 2: The method according to Embodiment 1, wherein timer values are configured through system information depending on the traffic flow by gNB.

Embodiment 3: The method according to any one of Embodiments 1 to 2, wherein adjustment can be done based on DCI or MAC CE.

Embodiment 4: The method according to any one of Embodiments 1 to 3, signaling can be UE specific or group of UEs which have same traffic flows.

Embodiment 5: The method according to Embodiment 4, RRC provides two mapping tables to the UE through dedicated RRC signaling message.

Embodiment 6: The method according to any one of Embodiments 1 to 5, wherein table one provides mapping between index and drx-onDurationTimer.

Embodiment 7: The method according to any one of Embodiments 1 to 6, wherein table two provides mapping between index and drx-InactivityTimer.

Embodiment 8: Method for Single DRX configuration for XR, wherein gNB indicates index during the active time of UE.

Embodiment 9: Apparatus for Single DRX configuration for XR by a UE, the apparatus comprising a wireless transceiver, a processor coupled with a memory in which computer program instructions are stored, said instructions being configured to implement steps of any one of Embodiments 1 to 7.

Embodiment 10: Apparatus for Single DRX configuration for XR by a gNB, the apparatus comprising a wireless transceiver, a processor coupled with a memory in which computer program instructions are stored, said instructions being configured to implement steps of Embodiment 8.

Embodiment 11: User Equipment comprising an apparatus according to Embodiment 9.

Embodiment 12: Base station comprising an apparatus according to Embodiment 10.

Embodiment 13: Wireless communication system, wherein the gNB comprises a processor coupled with a memory in which computer program instructions are stored, said instructions being configured to implement steps of Embodiment 8, and wherein the user equipment (UE) comprises a processor coupled with a memory in which computer program instructions are stored, said instructions being configured to implement steps of any one of Embodiments 1 to 7.

1. A method for discontinuous reception, DRX, configuration, the method being implemented by a user equipment, UE, wherein the UE is configured with a DRX cycle comprising an active time and an inactive time, wherein the active time is configured by a drx-onDurationTimer and a drx-InactivityTimer, wherein the method comprises:
in response to receiving, during the active time and from a base station, BS, an indication of an adjustment of the drx-onDurationTimer/drx-InactivityTimer values: modifying the drx-onDurationTimer/drx-InactivityTimer values based on the indicated adjustment,
in response to receiving no adjustment indication from the BS: continuing with the same drx-onDurationTimer/drx-InactivityTimer values.

2. The method according to claim 1, wherein the adjustment of the drx-onDurationTimer/drx-InactivityTimer values is determined based on at least one index indicated by the BS.

3. The method according to claim 2, wherein the adjustment of the drx-onDurationTimer/drx-InactivityTimer values is determined based on at least one mapping table between a plurality of indexes and respective timer values.

4. The method according to claim 3, wherein the adjustment of the drx-onDurationTimer/drx-InactivityTimer values is determined based on a first mapping table between a plurality of indexes and respective drx-onDurationTimer values and based on a second mapping table between a plurality of indexes and respective drx-InactivityTimer values.

5. The method according to claim 3, wherein the at least one mapping table between a plurality of indexes and respective timer values is provided to the UE through dedicated radio resource control signaling.

6. The method according to claim 1, wherein the adjustment indication is done based on downlink control information, DCI, or medium access control, MAC, control element, CE.

7. The method according to claim 1, wherein the adjustment indication is UE specific or for a group of UEs which have same traffic flows.

8. A user equipment, UE, comprising a wireless transceiver, a processor coupled with a memory in which computer program instructions are stored, said instructions being configured to implement a method according to claim 1.

9. A method for discontinuous reception, DRX, configuration, the method being implemented by a base station, BS, wherein a UE is configured with a DRX cycle comprising an active time and an inactive time, wherein the active time is configured by a drx-onDurationTimer and a drx-InactivityTimer, wherein the method comprises transmitting to the UE an indication of an adjustment of the drx-onDurationTimer/drx-InactivityTimer values during the active time of the DRX cycle.

10. The method according to claim 9, comprising determining an index based on a traffic flow of the UE and wherein the index is transmitted to the UE as an indication of an adjustment of the drx-onDurationTimer/drx-InactivityTimer values.

11. The method according to claim 10, comprising transmitting to the UE at least one mapping table between a plurality of indexes and respective timer values.

12. The method according to claim 11, comprising transmitting to the UE a first mapping table between a plurality of indexes and respective drx-onDurationTimer values and a second mapping table between a plurality of indexes and respective drx-InactivityTimer values.

13. The method according to claim 11, wherein the at least one mapping table between a plurality of indexes and respective timer values is transmitted through dedicated radio resource control signaling.

14. The method according to claim 9, wherein the adjustment indication is based on downlink control information, DCI, or medium access control, MAC, control element, CE.

15. The method according to claim 9, wherein the adjustment indication is UE specific or for a group of UEs which have same traffic flows.

16. A base station comprising a wireless transceiver, a processor coupled with a memory in which computer program instructions are stored, said instructions being configured to implement a method according to claim 9.

17. A wireless communication system comprising:
a base station comprising a wireless transceiver and a processor coupled with a memory in which computer program instructions are stored, said instructions being configured to implement a method for discontinuous reception, DRX, configuration, the method being implemented by a base station, BS, wherein a UE is configured with a DRX cycle comprising an active time and an inactive time, wherein the active time is configured by a drx-onDurationTimer and a drx-InactivityTimer, wherein the method comprises transmitting to the UE an indication of an adjustment of the drx-onDurationTimer/drx-InactivityTimer values during the active time of the DRX cycle, and
a user equipment, UE, comprising a wireless transceiver and a processor coupled with a memory in which computer program instructions are stored,
wherein said instructions the UE are configured to implement a method according to claim 1.
